(19) United States
(12) Patent Application Publication
(10) Pub. No.: US 2020/0244363 A1
(43) Pub. Date: Jul. 30, 2020

(54) ACTIVE OPTICAL CABLE

(71) Applicant: FUJIKURA LTD., Tokyo (JP)

(72) Inventor: Teijiro Ori, Chiba (JP)

(73) Assignee: FUJIKURA LTD., Tokyo (JP)

(21) Appl. No.: 16/634,968

(22) PCT Filed: May 10, 2018
(86) PCT No.: PCT/JP2018/018167

§ 371 Date: Jan. 29, 2020

(30) Foreign Application Priority Data
Aug. 15, 2017 (JP) 2017-156712

(51) Int. Cl. H04B 10/25; G02B 6/42; H04B 10/516; H04B 10/66

(52) U.S. Cl. CPC H04B 10/25891; H04B 10/66; H04B 10/516; G02B 6/4246

(57) ABSTRACT

An active optical cable that allows bidirectional communication includes: a plurality of optical fibers; and a first optical module and a second optical module that are coupled via the plurality of optical fibers. The first optical module includes a modulation light source that generates a first optical signal on which a first data signal is superimposed during a first time slot. The second optical module includes an optical modulator that converts a first branched optical signal, obtained by branching the first optical signal transmitted from the first optical module, into a second optical signal on which a second data signal is superimposed during a second time slot.

### TECHNICAL FIELD

The present invention relates to an active optical cable.

### BACKGROUND

An active optical cable (AOC), which is a transmission medium that is used as an alternative to a metal cable, has attracted attention. As illustrated in FIG. 1 of Patent Literature 1, an AOC that allows bidirectional communication with use of an optical signal includes: a cable that contains an optical fiber; and a first optical module and a second optical module that are provided at respective both ends of the cable. The first optical module and the second optical module each include (i) a transmitter module including a light emitting element and (ii) a receiver module including a light receiving element. Examples of the light emitting element include a vertical cavity surface emitting laser (VCSEL) and an edge emitting laser. Examples of the light receiving element include a P-Intrinsic-N (PIN)-photodiode and an avalanche photodiode.

The transmitter module of the first optical module is coupled to the receiver module of the second optical module via an optical fiber. The transmitter module converts an electric signal into an optical signal. The optical signal, into which the electric signal has been converted by the transmitter module, is transmitted via the optical fiber. The receiver module converts, into an electric signal, the optical signal, which has been transmitted via the optical fiber. The transmitter module of the first optical module, the receiver module of the second optical module, and the optical fiber thus constitute a first transmitter-receiver module.

The transmitter module of the second optical module is coupled to the receiver module of the first optical module via an optical fiber. The transmitter module of the second optical module, the receiver module of the first optical module, and the optical fiber constitute a second transmitter-receiver module as in the case of the first transmitter-receiver module.

Since the first transmitter-receiver module and the second transmitter-receiver module, each of which is configured as described earlier, are provided in directions opposite to each other, the AOC achieves bidirectional optical communication between a first external device to which the first optical module is connected and a second external device to which the second optical module is connected.

### PATENT LITERATURE

[Patent Literature 1]

Japanese Patent Application Publication Tokukai No. 2015-8380

According to a conventional AOC, an optical signal that is transmitted from a second optical module to a first optical module is generated by modulating light that is emitted from a light emitting element that is provided in the second optical module. Thus, in a case where insufficient electric power is supplied from a second external device to the second optical module, the light emitting element that is provided in the second optical module unstably emits light. This makes it impossible or unstable to transmit the optical signal from the second optical module to the first optical module.

### SUMMARY

One or more embodiments of the present invention provide an AOC that allows stable bidirectional communication also in a case where insufficient electric power is supplied from one of two external devices to which the AOC is connected.

An active optical cable in accordance with one or more embodiments of the present invention is an active optical cable which allows bidirectional communication, including: a plurality of optical fibers; and a first optical module and a second optical module which are coupled via the plurality of optical fibers, the first optical module including a modulation light source which generates a first optical signal on which a first data signal is superimposed during a first time slot, and the second optical module including an optical modulator which converts, into a second optical signal on which a second data signal is superimposed during a second time slot, a branched optical signal which is obtained by branching the first optical signal which is transmitted from the first optical module.

One or more embodiments of the present invention make it possible to achieve stable bidirectional communication also in a case where electric power that is supplied from one of two external devices that are connected via an AOC is insufficient to drive a light emitting element.

### BRIEF DESCRIPTION OF THE DRAWINGS

FIG. 1 is a block diagram illustrating a configuration of an active optical cable in accordance with one or more embodiments of the present invention.

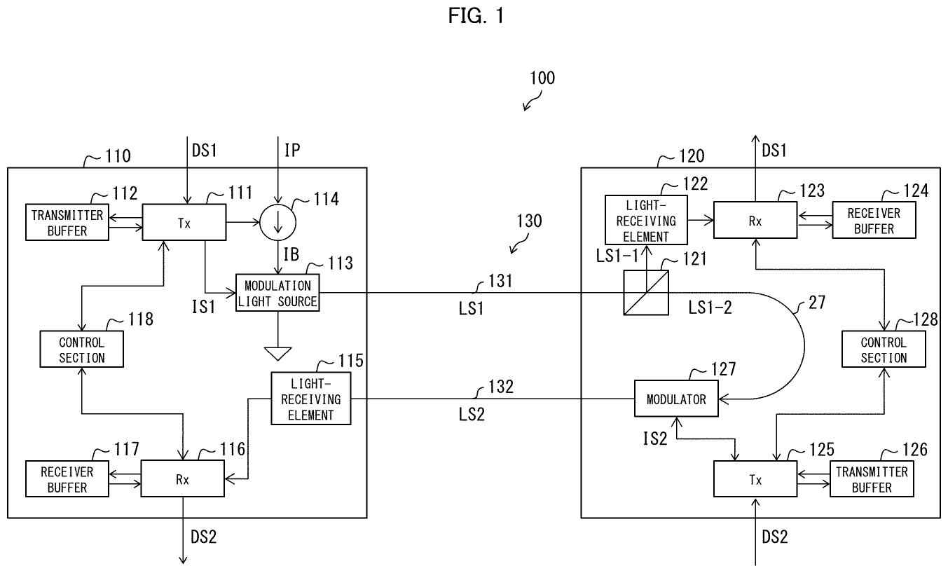

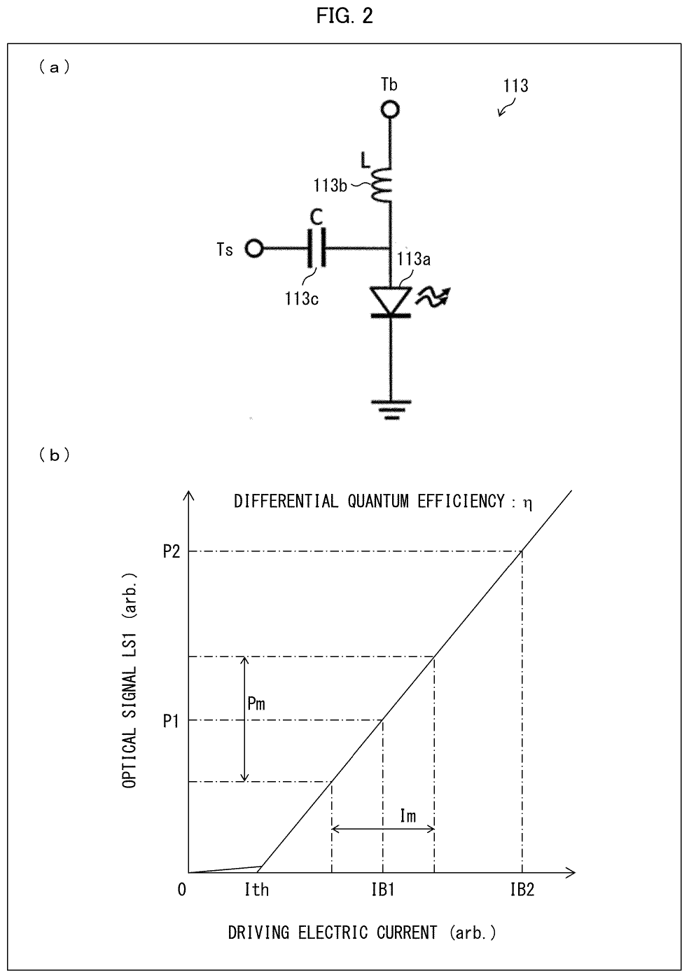

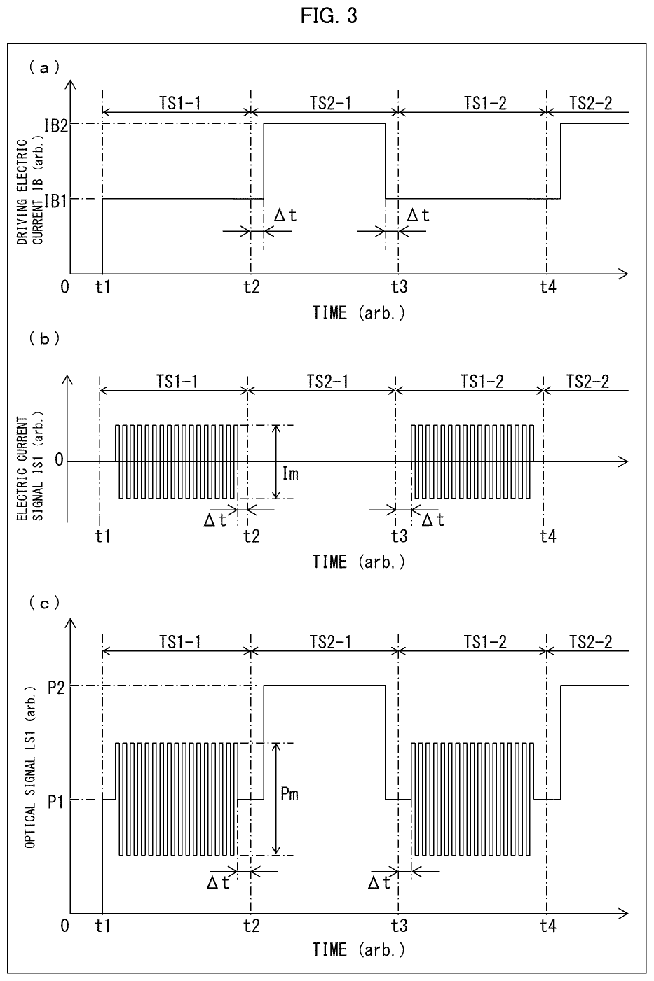

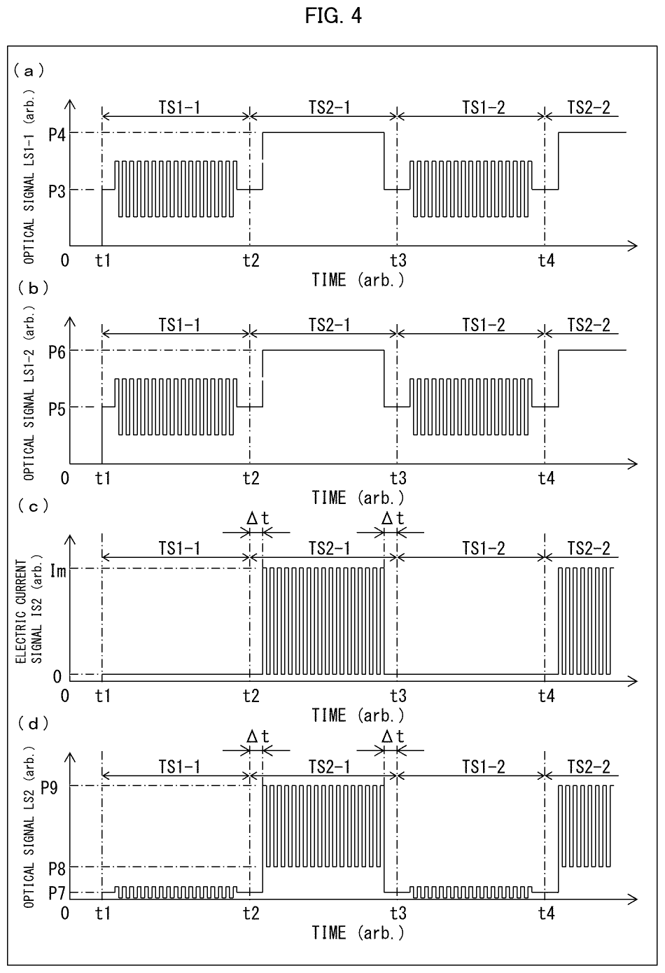

(a) of FIG. 2 is a circuit diagram showing a configuration example of a modulation light source of the active optical cable illustrated in FIG. 1. (b) of FIG. 2 is a graph showing a characteristic of the modulation light source.

(a) of FIG. 3 is a waveform chart of a bias electric current which is supplied from a bias electric current source to the modulation light source in a first optical module of the active optical cable illustrated in FIG. 1. (b) of FIG. 3 is a waveform chart of an electric current signal which is supplied from a transmitter circuit to the modulation light source in the first optical module of the active optical cable illustrated in FIG. 1. (c) of FIG. 3 is a waveform chart of an optical signal which is generated by the modulation light source in the first optical module of the active optical cable illustrated in FIG. 1.

(a) of FIG. 4 is a waveform chart of an optical signal which is supplied from an optical branching section to a light receiving element in a second optical module of the active optical cable illustrated in FIG. 1. (b) of FIG. 4 is a waveform chart of an optical signal which is supplied from the optical branching section to an optical modulator in the second optical module of the active optical cable illustrated in FIG. 1. (c) of FIG. 4 is a waveform chart of an electric current signal which is supplied to the optical modulator in the second optical module of the active optical cable illustrated in FIG. 1. (d) of FIG. 4 is a waveform chart of an optical signal which is generated by the optical modulator in the second optical module of the active optical cable illustrated in FIG. 1.

### DETAILED DESCRIPTION

(Overview of Active Optical Cable)

An active optical cable (AOC) including two optical modules that are optically coupled via an optical fiber is a cable that achieves bidirectional communication between two external devices with use of an optical signal. The AOC allows a large amount of data to be transmitted at a high speed. Thus, the AOC can replace a conventionally used metal cable.

Furthermore, an optical signal that is transmitted via an optical fiber is much smaller in transmission loss than an electric signal that is transmitted via a metal cable. This allows the AOC to achieve bidirectional communication also between two external devices that are at a long distance (e.g., not shorter than 10 m and not longer than 1000 m). It is difficult for a connection between the two external devices via a metal cable to achieve bidirectional communication in such a long distance.

Examples of the AOC that can be used include an InfiniB and (Registered Trademark) type cable, a cable conforming to a camera link standard, a cable conforming to a High-definition Digital Media Interface (HDMI, Registered Trademark) standard, and an a cable conforming to a Universal Serial Bus (USB) interface standard.

It is assumed that, for example, a personal computer and a camera, or a personal computer and an optical drive (e.g., a Blu-ray (Registered Trademark) disk drive) are connected via (i) an AOC conforming to a camera link standard and (ii) an AOC conforming to a USB interface standard. In this case, the personal computer may be sufficiently capable of supplying electric power, but the camera or the optical drive may be insufficiently capable of supplying electric power.

An AOC in accordance with one or more embodiments described below achieves stable bidirectional communication also in a case where electric power that is supplied from one of two external devices, to which the AOC is connected, is thus insufficient to drive a light emitting element. In the following description, an external device that is more capable of supplying electric power is assumed to be a first external device, and an external device that is less capable of supplying electric power is assumed to be a second external device.

(Configuration of AOC)

A configuration of an AOC 100 in accordance with one or more embodiments of the present invention is described below with reference to FIG. 1. FIG. 1 is a block diagram illustrating the configuration of the AOC 100.

As illustrated in FIG. 1, the AOC 100 includes (i) a cable 130 which contains two optical fibers 131 and 132, (ii) a first optical module 110 which is provided at one end of the cable 130, and (iii) a second optical module 120 which is provided at the other end of the cable 130. Use of the AOC 100 allows bidirectional communication between (a) the first external device (not illustrated) connected to the first optical module 110 and (b) the second external device (not illustrated) connected to the second optical module 120. Note that each of the first optical fiber 131 and the second optical fiber 132 can be, for example, a general-purpose single mode fiber.

The first optical module 110 has the following functions (1) and (2): (1) a function of transmitting a data signal DS1 (an example of a “first data signal” according to one or more embodiments of the present invention) to the second optical module 120 in a form of an optical signal LS1 (an example of a “first optical signal” according to one or more embodiments of the present invention), the data signal DS1 having been supplied from the first external device in a form of an electric signal; and (2) a function of supplying a data signal DS2 (an example of a “second data signal” according to one or more embodiments of the present invention) to the first external device in the form of an electric signal, the data signal DS2 having been received from the second optical module 120 in a form of an optical signal LS2 (an example of a “second optical signal” according to one or more embodiments of the present invention).

The second optical module 120 has the following functions (1) and (2): (1) a function of transmitting the data signal DS2 to the first optical module 110 in the form of the optical signal LS2, the data signal DS2 having been supplied from the second external device in the form of an electric signal; and (2) a function of supplying the data signal DS1 to the first external device in the form of an electric signal, the data signal DS1 having been received from the first optical module 110 in the form of the optical signal LS1.

The first optical fiber 131, via which the first optical module 110 and the second optical module 120 are coupled, serves as a transmission medium through which the optical signal LS1 is transmitted from the first optical module 110 to the second optical module 120. The second optical fiber 132, via which the first optical module 110 and the second optical module 120 are coupled, serves as a transmission medium through which the optical signal LS2 is transmitted from the second optical module 120 to the first optical module 110.

According to the AOC 100, the optical signals LS1 and LS2 are transmitted and received with use of a time division system. More specifically, according to the AOC 100, (i) a time slot during which the data signal DS1 is superimposed on the optical signal LS1 which is transmitted from the first optical module 110 to the second optical module 120 and (ii) a time slot during which the data signal DS2 is superimposed on the optical signal LS2 which is transmitted from the second optical module 120 to the first optical module 110 are alternately repeated.

The time slot during which the data signal DS1 is superimposed on the optical signal LS1 which is transmitted from the first optical module 110 to the second optical module 120 is hereinafter referred to as a “time slot TS1” (an example of a “first time slot” according to one or more embodiments of the present invention). Note that repeated time slots TS1 which need to be distinguished from each other are referred to as a “time slot TS1-1”, a “time slot TS1-2”, a “time slot TS1-3”, and so forth in order of time.

The time slot during which the data signal DS2 is superimposed on the optical signal which is transmitted from the second optical module 120 to the first optical module 110 is hereinafter referred to as a “time slot TS2” (an example of a “second time slot” according to one or more embodiments of the present invention). Note that repeated time slots TS2 which need to be distinguished from each other are referred to as a “time slot TS2-1”, a “time slot TS2-2”, a “time slot TS2-3”, and so forth in order of time.

One or more embodiments assume that the time slots TS1 and the time slots TS2 alternate in the following order: the time slot TS1-1, the time slot TS2-1, the time slot TS1-2, the time slot TS2-2, and so forth. Note, however, that one or more embodiments of the present invention do not necessarily need to be thus configured. Specifically, the time slots TS1 and the time slots TS2 can alternatively alternate in the following order: the time slot TS2-1, the time slot TS1-1, the time slot TS2-2, the time slot TS1-2, and so forth.

One or more embodiments assume that a time slot TS1 and a time slot TS2 are equal in length. Note, however, that one or more embodiments of the present invention do not necessarily need to be thus configured. Specifically, the time slot TS1 and the time slot TS2 can alternatively have respective different lengths. For example, in a case where a larger amount of data is expected to be transmitted from the first optical module 110 to the second optical module 120 than from the second optical module 120 to the first optical module 110, one or more embodiments of the present invention can be configured such that the time slot TS1 is longer than the time slot TS2. In contrast, in a case where a larger amount of data is expected to be transmitted from the second optical module 120 to the first optical module 110 than from the first optical module 110 to the second optical module 120, one or more embodiments of the present invention can be configured such that the time slot TS2 is longer than the time slot TS1.

(Configuration of First Optical Module)

By referring to FIG. 1 again, the following description discusses a configuration of the first optical module 110 of the AOC 100.

As illustrated in FIG. 1, the first optical module 110 includes a transmitter circuit 111, a transmitter buffer 112, a modulation light source 113, a bias electric current source 114, a light receiving element 115, a receiver circuit 116, a receiver buffer 117, and a control section 118.

The transmitter circuit 111, the transmitter buffer 112, and the modulation light source 113 are configured to transmit the data signal DS1 to the second optical module 120 in the form of the optical signal LS1, the data signal DS1 having been supplied from the first external device in the form of an electric signal, which can alternatively be a voltage signal or an electric current signal. The transmitter circuit 111, the transmitter buffer 112, and the modulation light source 113 each operate as described below.

Specifically, during each time slot TS1 (except the earliest time slot TS1-1) and a time slot TS2 immediately preceding that time slot TS1, the transmitter circuit 111 writes the data signal DS1 into the transmitter buffer 112, the data signal DS1 having been supplied from the first external device in the form of an electric signal. During the time slot TS1, the transmitter circuit 111 (i) reads the data signal DS1 from the transmitter buffer 112 at a reading speed which is approximately twice as high as a writing speed and (ii) supplies the data signal DS1 thus read to the modulation light source 113 in a form of an electric current signal IS1 (this operation is hereinafter also referred to as a “transmitting operation”). Furthermore, during the time slot TS1, the modulation light source 113 modulates, in accordance with the electric current signal IS1 which has been supplied from the transmitter circuit 111, a bias electric current IB which has been supplied from the bias electric current source 114 to a laser diode (described later). That is, the modulation light source 113 generates the optical signal LS1 on which the data signal DS1 is superimposed during the time slot TS1. During the time slot TS2, the optical signal LS1 is continuous light on which no data signal is superimposed. The optical signal LS1 thus generated by the modulation light source 113 is transmitted to the second optical module 120 through the first optical fiber 131.

The transmitter circuit 111 can be constituted by, for example, a driver such as a complementary metal oxide semiconductor (CMOS) or a bipolar complementary metal oxide semiconductor (BiCMOS). The transmitter buffer 112 can be constituted by, for example, a common integrated circuit (IC). A specific example of how the modulation light source 113 is configured will be described later with reference to another drawing that is different from FIG. 1.

The light receiving element 115, the receiver circuit 116, and the receiver buffer 117 are configured to (i) convert, into the data signal DS2 in the form of an electric signal, which can alternatively be a voltage signal or an electric current signal, the optical signal LS2 which has been received from the second optical module 120 and (ii) supply the data signal DS2 to the first external device. The light receiving element 115, the receiver circuit 116, and the receiver buffer 117 have respective functions described below.

Specifically, during each time slot TS2, the light receiving element 115 (i) converts, into an electric current signal, the optical signal LS2 which has been received from the second optical module 120 through the second optical fiber 132 and (ii) supplies the electric current signal to the receiver circuit 116. Furthermore, during that time slot TS2, the receiver circuit 116 writes, into the receiver buffer 117, the data signal DS2 which has been supplied from the light receiving element 115 in a form of the electric current signal. Then, during the time slot TS2 and a time slot TS1 immediately following the time slot TS2, the receiver circuit 116 (i) reads the data signal DS2 from the receiver buffer 117 at a reading speed which is approximately half as high as a writing speed and (ii) supplies the data signal DS2 thus read to the first external device in the form of an electric signal (this operation is hereinafter also referred to as a “receiving operation”).

The light receiving element 115 can be, for example, a photodiode such as a P-Intrinsic-N (PIN) photodiode or an avalanche photodiode. The receiver circuit 116 can be constituted by, for example, a transimpedance amplifier and a limiting amplifier. In this case, the electric current signal which has been obtained by the light receiving element 115 is amplified by the transimpedance amplifier and the limiting amplifier, and the electric current signal thus amplified is supplied to the first external device. The receiver buffer 117 can be constituted by, for example, a common integrated circuit (IC).

The control section 118 is configured to control each of the transmitter circuit 111 and the receiver circuit 116. For example, the control section 118 causes the transmitter circuit 111 to (i) start the transmitting operation (described earlier) at a starting point of the time slot TS1 and (ii) finish the transmitting operation at an end point of the time slot TS1. Furthermore, for example, the control section 118 causes the receiver circuit 116 to (i) start the receiving operation (described earlier) at a starting point of the time slot TS2 and (ii) finish the receiving operation at an end point of the time slot TS2. Note that the control section 118 can be, for example, a microcontroller.

(Configuration Example of Modulation Light Source)

A configuration example of the modulation light source 113 of the first optical module 110 is described below with reference to FIG. 2. (a) of FIG. 2 is a circuit diagram in accordance with the configuration example of the modulation light source 113 and is a graph showing a characteristic of the modulation light source 113.

The modulation light source 113 is a modulation light source which generates the optical signal LS1 by direct modulation. As illustrated in (a) of FIG. 2, the modulation light source 113 can be constituted by a laser diode (hereinafter referred to as an “LD”) 113a, a coil 113b, and a capacitor 113c. The LD 113a can be, for example, a distributed-feedback laser diode (DFB-LD) or a Fabry-Perot laser diode (FP-LD). According to one or more embodiments, the LD 113a is a DFB-LD having a lasing wavelength of 1550 nm.

The LD 113a has an anode to which the coil 113b and the capacitor 113c are connected in parallel. The coil 113b has a bias terminal Tb to which the bias electric current IB is supplied from the bias electric current source 114 (described earlier), the bias terminal Tb being a first terminal of the coil 113b which first terminal is opposite from a second terminal of the coil 113b which second terminal is located on the LD 113a side. The capacitor 113c has a signal terminal Ts to which the electric current signal IS1 is supplied from the transmitter circuit 111 (described earlier), the signal terminal Ts being a first terminal of the capacitor 113c which first terminal is opposite from a second terminal of the capacitor 113c which second terminal is located on the LD 113a side. Thus, the anode of the LD 113a is supplied with a driving electric current obtained by combining the bias electric current IB and an alternating current component of the electric current signal IS1. Note that the LD 113a has a grounded cathode.

As shown in (b) of FIG. 2, in a case where the driving electric current is higher than a threshold electric current Ith, the LD 113a generates the optical signal LS1 whose power is in proportion to the driving electric current. Thus, in a case where the bias electric current IB has an intensity of IB1 and the electric current signal IS1 has an amplitude of Im, the LD 113a generates the optical signal LS1 whose power oscillates within the range of P1±Pm/2 centering on P1.

The modulation light source 113 in accordance with the present configuration example generates the optical signal LS1 by direct modulation. Note, however, that the modulation light source 113 in accordance with one or more embodiments of the present invention does not necessarily need to be thus configured. Specifically, the modulation light source 113 can alternatively be constituted by a light source and an external modulator. In this case, the light source can be, for example, a vertical cavity surface emitting laser (VCSEL) or an edge emitting laser. The external modulator can be, for example, an optical modulator such as an electroabsorption modulator, a Mach-Zehnder (MZ) modulator (e.g., a lithium niobate (LN) (LiNbO₃) modulator), or a silicon modulator.

As described earlier, according to the AOC 1 in accordance with one or more embodiments, the modulation light source 113 of the first optical module 110 can be a modulation light source which generates the optical signal LS1 by direct modulation. As compared with the first optical module 110 whose modulation light source 113 is a modulation light source which generates the optical signal LS1 by indirect modulation, the first optical module 110 whose modulation light source 113 is a modulation light source which generates the optical signal LS1 by direct modulation further dispenses with an external modulator, and, accordingly, can achieve the AOC 1 in which the first optical module 110 has a simpler configuration.

(Optical signal generated in first optical module) The optical signal LS1 which is generated in the first optical module 110 is described here with reference to FIG. 3.

For example, the bias electric current source 114 of the first optical module 110 supplies, to the modulation light source 113, the bias electric current IB which (i) has a value of IB1 during the time slot TS1 and (ii) has a value of IB2, which is higher than IB1, during the time slot TS2. (a) of FIG. 3 is a waveform chart of the bias electric current IB which is supplied from the bias electric current source 114 to the modulation light source 113 in this case.

For example, during the time slot TS1, the transmitter circuit 111 of the first optical module 110 supplies, to the modulation light source 113, the electric current signal IS1 which (i) has a value of +Im/2 while the data signal DS1 is at a high level (i.e., the data signal DS1 goes high) and (ii) has a value of −Im/2 while the data signal DS1 is at a low level (i.e., the data signal DS1 goes low). Note here that Im, which is the amplitude of the electric current signal IS1, is set so as to satisfy Im/2<IB2−IB1. During the time slot TS2, the electric current signal IS1 has a value of, for example, 0 (zero). (b) of FIG. 3 is a waveform chart of the electric current signal IS1 which is supplied from the transmitter circuit 111 to the modulation light source 113 in this case.

For example, the modulation light source 113 of the first optical module 110 generates the optical signal LS1 whose power is proportional to a sum of the bias electric current IB and the electric current signal IS1. In this case, the optical signal LS1 which is generated by the modulation light source 113 is an optical signal on which the data signal DS1 is superimposed during the time slot TS1. (c) of FIG. 3 is a waveform chart of the optical signal LS1 which is generated by the modulation light source 113 in this case. Since the amplitude Im of the electric current signal IS1 is set so as to satisfy Im/2<IB2−IB1, power P2 of the optical signal LS1 which power P2 is measured during the time slot TS2 is higher than any of power P1, power P1+Pm/2, and power P1−Pm/2 of the optical signal LS1 which are measured during the time slot TS1. Note here that Pm is an amplitude of the optical signal LS1.

Note that the optical signal LS1 has, during the time slot TS2, the power P2 which is higher than the power P1+Pm/2 measured during a high level period of the time slot TS1 (see (c) of FIG. 3). Thus, a threshold which is set between the power P2 measured during the time slot TS2 and the power P1+Pm/2 measured during the high level period of the time slot TS1 can be used to achieve the AOC 100 which allows the second optical module 120 to relatively easily distinguish between the time slot TS1 and the time slot TS2. Note here that the term “the high level period of the time slot TS1” refers to a period of the time slot TS1 during which period the data signal DS1 is at the high level and at least the power of the optical signal LS1 can have a maximum value of P1+Pm/2.

Note that the value of the bias electric current IB can change from IB1 to IB2 at (i) the starting point of the time slot TS2 (a time point t2 or a time point t4 shown in FIG. 3), (ii) a time point which is earlier than the starting point of the time slot TS2 by a time Δt, or (iii) a time point which is later than the starting point of the time slot TS2 by the time Δt. (a) of FIG. 3 shows an example of a case where the value of the bias electric current IB changes from IB1 to IB2 at the time point which is later than the starting point of the time slot TS2 by the time Δt. Note also that the value of the bias electric current IB can change from IB2 to IB1 at (i) the end point of the time slot TS2 (a time point t3 shown in FIG. 3), (ii) a time point which is earlier than the end point of the time slot TS2 by the time Δt, or (iii) a time point which is later than the end point of the time slot TS2 by the time Δt. (a) of FIG. 3 shows an example of a case where the value of the bias electric current IB changes from IB2 to IB1 at the time point which is earlier than the starting point of the time slot TS2 by the time Δt.

A period during which the data signal DS1 is superimposed on the optical signal LS1 can start at (i) the starting point of the time slot TS1 (a time point t1 or the time point t3 shown in FIG. 3) or (ii) a time point which is later than the starting point of the time slot TS1 by the time Δt (see (b) and (c) of FIG. 3). The period during which the data signal DS1 is superimposed on the optical signal LS1 can end at (i) the end point of the time slot TS1 (the time point t2 or the time point t4 shown in FIG. 3) or (ii) a time point which is earlier than the end point of the time slot TS1 by the time Δt (see (c) and (d) of FIG. 3).

(Configuration of Second Optical Module)

By referring to FIG. 1 again, the following description discusses a configuration of the second optical module 120 of the AOC 100.

As illustrated in FIG. 1, the second optical module 120 includes an optical branching section 121, a light receiving element 122, a receiver circuit 123, a receiver buffer 124, a transmitter circuit 125, a transmitter buffer 126, an optical modulator 127, and a control section 128.

The optical branching section 121 is configured to branch, into an optical signal LS1-1 (an example of “another branched optical signal” of the present invention) and an optical signal LS1-2 (an example of a “branched optical signal” of the present invention), the optical signal LS1 which has been received from the first optical module 110. The obtained optical signal LS1-1 and the obtained optical signal LS1-2 are supplied to the light receiving element 122 and the optical modulator 127, respectively. Note that the optical branching section 121 can be, for example, a half mirror.

The light receiving element 122, the receiver circuit 123, and the receiver buffer 124 are configured to (i) convert, into the data signal DS1 in the form of an electric signal, which can alternatively be an electric current signal or a voltage signal, the optical signal LS1-1 which has been received from the optical branching section 121 and (ii) supply the data signal DS1 to the first external device. The light receiving element 122, the receiver circuit 123, and the receiver buffer 124 each operate as described below.

Specifically, during each time slot TS1, the light receiving element 122 (i) converts, into an electric current signal, the optical signal LS1-1 which has been received from the optical branching section 121 and (ii) supplies the electric current signal to the receiver circuit 123. Furthermore, during that time slot TS1, the receiver circuit 123 writes, into the receiver buffer 124, the data signal DS1 which has been supplied from the light receiving element 122 in the form of the electric current signal. Then, during the time slot TS1 and a time slot TS2 immediately following the time slot TS1, the receiver circuit 123 (i) reads the data signal DS1 from the receiver buffer 124 at a reading speed which is approximately half as high as a writing speed and (ii) supplies the data signal DS1 thus read to the second external device in the form of an electric signal (this operation is hereinafter also referred to as a “receiving operation”).

The light receiving element 122 can be, for example, a photodiode such as a P-Intrinsic-N (PIN) photodiode or an avalanche photodiode. The receiver circuit 123 can be constituted by, for example, a transimpedance amplifier and a limiting amplifier. In this case, the electric current signal which has been obtained by the light receiving element 122 is amplified by the transimpedance amplifier and the limiting amplifier, and the electric current signal thus amplified is supplied to the second external device. The receiver buffer 124 can be constituted by, for example, a common integrated circuit (IC).

The transmitter circuit 125, the transmitter buffer 126, and the optical modulator 127 are configured to transmit the data signal DS2 to the first optical module 110 in the form of the optical signal LS2, the data signal DS2 having been supplied from the second external device in the form of an electric signal, which can alternatively be a voltage signal or an electric current signal. The transmitter circuit 125, the transmitter buffer 126, and the optical modulator 127 each operate as described below.

Specifically, during each time slot TS2 and a time slot TS1 immediately preceding that time slot TS2, the transmitter circuit 125 writes the data signal DS2 into the transmitter buffer 126, the data signal DS2 having been supplied from the second external device in the form of an electric signal. During the time slot TS2, the transmitter circuit 125 (i) reads the data signal DS2 from the transmitter buffer 126 at a reading speed which is approximately twice as high as a writing speed and (ii) supplies the data signal DS2 thus read to the optical modulator 127 in a form of an electric current signal IS2 (this operation is hereinafter also referred to as a “transmitting operation”). Furthermore, during the time slot TS2, the optical modulator 127 modulates, in accordance with the electric current signal IS2 which has been supplied from the transmitter circuit 125, the optical signal LS1-2 which has been supplied from the optical branching section 121. That is, the optical modulator 127 converts the optical signal LS1-2 into the optical signal LS2 on which the data signal DS2 is superimposed during the time slot TS2. The optical signal LS2 which has been generated by the optical modulator 127 is transmitted to the first optical module 110 through the second optical fiber 132.

The transmitter circuit 125 can be constituted by, for example, a driver such as a complementary metal oxide semiconductor (CMOS) or a bipolar complementary metal oxide semiconductor (BiCMOS). The transmitter buffer 126 can be constituted by, for example, a common integrated circuit (IC). The optical modulator 127 can be, for example, an electroabsorption modulator or a Mach-Zehnder (MZ) modulator such as a lithium niobate (LN) (LiNbO₃) modulator or a silicon modulator.

According to one or more embodiments, sections (in particular, the optical branching section 121, the light receiving element 122, and the optical modulator 127) of the second optical module 120 are integrated on a single silicon on insulator (SOI) substrate. An optical waveguide via which the optical branching section 121 and the light receiving element 122 are connected and an optical waveguide via which the optical branching section 121 and the optical modulator 127 are connected can also be integrated on the single SOI substrate. With the configuration, the second optical module 120 can have a smaller size as compared with a case where the optical branching section 121, the light receiving element 122, and the optical modulator 127 are combined as discrete optical components. Furthermore, the configuration makes it possible to achieve the AOC 100 which can be manufactured at lower cost.

The control section 128 is configured to control each of the transmitter circuit 125 and the receiver circuit 123. For example, the control section 128 causes the transmitter circuit 125 to (i) start the transmitting operation (described earlier) at the starting point of the time slot TS2 and (ii) finish the transmitting operation at the end point of the time slot TS2. Furthermore, for example, the control section 128 causes the receiver circuit 123 to (i) start the receiving operation (described earlier) at the starting point of the time slot TS1 and (ii) finish the receiving operation at the end point of the time slot TS1. Note that the control section 128 can be, for example, a microcontroller.

(Optical Signal Generated in Second Optical Module)

The optical signal LS2 which is generated in the second optical module 120 is described here with reference to FIG. 4.

For example, the optical branching section 121 of the second optical module 120 is configured to branch the optical signal LS1, which has been received from the first optical module 110, into the optical signal LS1-1 and the optical signal LS1-2 at a predetermined ratio. (a) of FIG. 4 is a waveform chart of the optical signal LS1-1 which is supplied from the optical branching section 121 to the light receiving element 122 in this case. (b) of FIG. 4 is a waveform chart of the optical signal LS1-2 which is supplied from the optical branching section 121 to the optical modulator 127 in this case. During the time slot TS1, a sum of (i) average power P3 of the optical signal LS1-1 and (ii) average power P5 of the optical signal LS1-2 is obtained by subtracting, from the power P1 of the optical signal LS1 (see (c) of FIG. 3), optical losses which occur in the optical fiber 131 and the optical branching section 121, respectively. During the time slot TS2, a sum of (i) power P4 of the optical signal LS1-1 and (ii) power P6 of the optical signal LS1-2 is obtained by subtracting, from the power P2 of the optical signal LS1 (see (c) of FIG. 3), the optical losses which occur in the optical fiber 131 and the optical branching section 121, respectively.

For example, during the time slot TS2, the transmitter circuit 125 of the second optical module 120 supplies, to the optical modulator 127, the electric current signal IS2 which (i) has a value of Im while the data signal DS2 is at a high level and (ii) has a value of 0 while the data signal DS2 is at a low level. Note here that Im is an amplitude of the electric current signal IS2. During the time slot TS1, the electric current signal IS2 has a value of, for example, 0 (zero). (c) of FIG. 4 is a waveform chart of the electric current signal IS2 which is supplied from the transmitter circuit 125 to the optical modulator 127 in this case.

The optical modulator 127 of the second optical module 120 can be constituted by, for example, an on-off modulator which carries out on-off modulation with respect to the optical signal LS1-2 which has been supplied from the optical branching section 121. In a case where the electric current signal IS2 has a value of Im, the optical modulator 127 which is constituted by such an on-off modulator transmits therethrough the optical signal LS1-2 which has been supplied from the optical branching section 121. In contrast, in a case where the electric current signal IS2 has a value of 0, the optical modulator 127 which is constituted by such an on-off modulator blocks the optical signal LS1-2 which has been supplied from the optical branching section 121. Note here that the electric current signal IS2 has a value of 0 at all times during the time slot TS1. In contrast, during the time slot TS2, the electric current signal IS2 (i) has a value of Im while the data signal DS2 is at a high level and (ii) has a value of 0 while the data signal DS2 is at a low level. Thus, the optical modulator 127 (1) blocks the optical signal LS1-2 during the time slot TS1 and (2) during the time slot TS2, (i) transmits therethrough the optical signal LS1-2 while the data signal DS2 is at a high level and (ii) blocks the optical signal LS1-2 while the data signal DS2 is at a low level. (d) of FIG. 4 is a waveform chart of the optical signal LS2 which is generated by the optical modulator 127 in this case. During the time slot TS1, since the electric current signal IS2 has a value of 0, average power P7 of the optical signal LS2 is obtained by subtracting, from the average power P5 of the optical signal LS1-2, an optical loss which occurs in the optical modulator 127 which blocks the optical signal LS1-2. During the time slot TS2, since the electric current signal IS2 has a value of 0, power P8 which the optical signal LS2 has while the data signal DS2 is at a low level is obtained by subtracting, from the power P6 of the optical signal LS1-2, the optical loss which occurs in the optical modulator 127 which blocks the optical signal LS1-2. During the time slot TS2, since the electric current signal IS2 has a value of Im, power P9 which the optical signal LS2 has while the data signal DS2 is at a high level is obtained by subtracting, from the power P6 of the optical signal LS1-2, the optical loss which occurs in the optical modulator 127 which blocks the optical signal LS1-2. Note that a greater optical loss occurs in the optical modulator 127 which blocks the optical signal LS1-2 than in the optical modulator 127 which transmits therethrough the optical signal LS1-2. This is because of the following reason. Specifically, in a case where the optical modulator 127 transmits therethrough the optical signal LS1-2, most of light which has been supplied to the optical modulator 127 passes through the optical modulator 127 without being lost. In contrast, in a case where the optical modulator 127 blocks the optical signal LS1-2, most of light which has been supplied to the optical modulator 127 is lost without passing through the optical modulator 127.

Note that the optical signal LS2 has, during the high level period of the time slot TS1, power which is lower than power measured during a low level period of the time slot TS2 (see (d) of FIG. 4). Thus, a threshold which is set between the power measured during the high level period of the time slot TS1 and the power P8 measured during the low level period of the time slot TS2 can be used to achieve the AOC 100 which allows the first optical module 110 to relatively easily distinguish between the time slot TS1 and the time slot TS2. Note here that the term “the high level period of the time slot TS1” refers to a period of the time slot TS1 during which period the data signal DS1 is at a high level and at least the power of the optical signal LS2 can have a maximum value. In contrast, the term “the low level period of the time slot TS2” refers to a period of the time slot TS2 during which period the data signal DS2 is at a low level and at least the power of the optical signal LS2 can have a minimum value of P8.

A period during which the data signal DS2 is superimposed on the optical signal LS2 can start at (i) the starting point of the time slot TS2 (the time point t2 or the time point t4 shown in FIG. 4) or (ii) a time point which is later than the starting point of the time slot TS2 by the time Δt (see (c) and (d) of FIG. 4). The period during which the data signal DS2 is superimposed on the optical signal LS2 can end at (i) the end point of the time slot TS2 (the time point t3 shown in FIG. 4) or (ii) a time point which is earlier than the end point of the time slot TS2 by the time Δt (see (c) and (d) of FIG. 4).

According to a conventional AOC, an optical signal that is transmitted from a second optical module to a first optical module is generated by modulating light that is emitted from a light emitting element that is provided in the second optical module. Thus, in a case where insufficient electric power is supplied from a second external device to the second optical module, the light emitting element that is provided in the second external device unstably emits light. This makes it impossible or unstable to transmit the optical signal from the second optical module to the first optical module. Thus, in a case where insufficient electric power is supplied from the second external device to the second optical module, it is difficult to achieve stable bidirectional communication.

In contrast, according to the AOC 1 in accordance with one or more embodiments, (i) the first optical module 110 includes the modulation light source 113 which generates the optical signal LS1 on which the data signal DS1 is superimposed during the time slot TS1, and (ii) the second optical module 120 includes the optical modulator 127 which converts, into the optical signal LS2 on which the data signal DS2 is superimposed during the time slot TS2, the optical signal LS1-2 which is obtained by branching the optical signal LS1 which is transmitted from the first optical module 110. That is, according to the AOC 1 in accordance with one or more embodiments, the optical signal LS2 which is transmitted from the second optical module 120 to the first optical module 110 is generated by modulating not light which is emitted from a light emitting element which is provided in the second optical module 120 but the optical signal LS1-2 which is obtained by branching the optical signal LS1 which is transmitted from the first optical module 110. Thus, the AOC 1 in accordance with one or more embodiments makes it unnecessary to not only provide the second optical module 120 with a light source for generating the optical signal LS2 which is transmitted from the second optical module 120 to the first optical module 110 but also supply, from the second external device to the second optical module 120, electric power by which to generate the optical signal LS2. In fact, according to the AOC 1 in accordance with one or more embodiments, the second optical module 120 is provided with no light source for generating the optical signal LS2 which is transmitted from the second optical module 120 to the first optical module 110, and no electric power by which to generate the optical signal LS2 is supplied to the second optical module 120. Thus, also in a case where the AOC 1 is connected to two external devices and insufficient electric power is supplied from a second external device, which is one of the two external devices, to the second optical module 120, the optical signal LS2 can be stably transmitted from the second optical module 120 to the first optical module 110. This makes it possible to achieve the AOC 1 which allows bidirectional communication also in a case where the AOC 1 is connected to two external devices and insufficient electric power is supplied from a second external device, which is one of the two external devices, to the second optical module 120.

The AOC 1 in accordance with one or more embodiments is configured such that a light source for generating the optical signal LS2 which is transmitted from the second optical module 120 to the first optical module 110 is entirely included in the first optical module 110 and is not included in the second optical module 120. Note, however, that one or more embodiments of the present invention do not necessarily need to be thus configured. Specifically, the AOC 1 can alternatively be configured such that a part of a light source for generating the optical signal LS2 which is transmitted from the second optical module 120 to the first optical module 110 is included in the first optical module 110 and the other part of the light source is included in the second optical module 120. In this case, lower electric power consumption can be achieved than in a case where a light source for generating the optical signal LS2 which is transmitted from the second optical module 120 to the first optical module 110 is entirely included in the second optical module 120. This makes it possible to achieve the AOC 1 which allows more stable bidirectional communication than a conventional AOC also in a case where the AOC 1 is connected to two external devices and insufficient electric power is supplied from a second external device, which is one of the two external devices, to the second optical module 120.

One or more embodiments of the present invention can also be expressed as follows:

An active optical cable (100) in accordance with one or more embodiments allows bidirectional communication, includes: a plurality of optical fibers (131 and 132); and a first optical module (110) and a second optical module (120) which are coupled via the plurality of optical fibers (131 and 132), the first optical module (110) including a modulation light source (113) which generates a first optical signal (LS1) on which a first data signal (DS1) is superimposed during a first time slot (TS1), and the second optical module (120) including an optical modulator (127) which converts, into a second optical signal (LS2) on which a second data signal (DS2) is superimposed during a second time slot (TS2), a branched optical signal (LS1-2) which is obtained by branching the first optical signal (LS1) which is transmitted from the first optical module (110).

The active optical cable (100) in accordance with one or more embodiments may be configured such that the second optical module (120) includes no light source for generating the second optical signal (LS2).

The active optical cable (100) in accordance with one or more embodiments may be configured such that the first optical signal (LS1) is an optical signal whose power is higher during the second time slot (TS2) than during a period of the first time slot (TS1) during which period the first data signal (DS1) is at a high level.

The active optical cable (100) in accordance with one or more embodiments may be configured such that the optical modulator (127) is an on-off modulator which (1) blocks the branched optical signal (LS1-2) during the first time slot (TS1) and (2) during the second time slot (TS2), (i) transmits therethrough the branched optical signal (LS1-2) while the second data signal (DS2) is at a high level and (ii) blocks the branched optical signal (LS1-2) while the second data signal (DS2) is at a low level.

The active optical cable (100) in accordance with one or more embodiments may be configured such that the modulation light source (113) generates the first optical signal (LS1) by direct modulation.

The active optical cable (100) in accordance with one or more embodiments may be configured such that: the second optical module (120) further includes: an optical branching section (121) which branches the first optical signal (LS1) into the branched optical signal (LS1-2) and another branched optical signal (LS1-1); and a light receiving element (122) which converts the another branched optical signal (LS1-2) into an electric current signal; and the optical branching section (121), the optical modulator (127), and the light receiving element (122) are integrated on a single SOI substrate.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

100 Active optical cable (AOC)
110 First optical module
111 Transmitter circuit
112 Transmitter buffer
113 Modulation light source
114 Bias electric current source
115 Light receiving element
116 Receiver circuit
117 Receiver buffer
118 Control section
120 Second optical module
121 Optical branching section
122 Light receiving element
123 Receiver circuit
124 Receiver buffer
125 Transmitter circuit
126 Transmitter buffer
127 Optical modulator
128 Control section
131 Optical fiber
132 Optical fiber

1. An active optical cable that allows bidirectional communication, comprising:
a plurality of optical fibers; and
a first optical module and a second optical module that are coupled via the plurality of optical fibers, wherein
the first optical module comprises a modulation light source that generates a first optical signal on which a first data signal is superimposed during a first time slot, and
the second optical module comprises an optical modulator that converts a first branched optical signal, obtained by branching the first optical signal transmitted from the first optical module, into a second optical signal on which a second data signal is superimposed during a second time slot.

2. The active optical cable according to claim 1, wherein the second optical module does not have any light emitting element for generating the second optical signal.

3. The active optical cable according to claim 1, wherein
a power of the first optical signal is higher during the second time slot than during a period of the first time slot, and
the first data signal goes high during the period.

4. The active optical cable according to claim 1, wherein the optical modulator is an on-off modulator that:
blocks the first branched optical signal during the first time slot, and
during the second time slot,
transmits the first branched optical signal while the second data signal is high, and
blocks the first branched optical signal while the second data signal is low.

5. The active optical cable according to claim 1, wherein the modulation light source generates the first optical signal by direct modulation.

6. The active optical cable according to claim 1, wherein:
the second optical module further comprises:
an optical branching section that branches the first optical signal into the first branched optical signal and another a branched optical signal; and
a light receiving element which converts the second branched optical signal into an electric current signal; and
the optical branching section, the optical modulator, and the light receiving element are integrated on a single silicon on insulator (SOI) substrate.
